(19) United States
(12) Patent Application Publication
(10) Pub. No.: US 2008/0117449 A1
(43) Pub. Date: May 22, 2008

(54) METHOD AND SYSTEM FOR RECALLING PRINTED DOCUMENTS

(76) Inventors: Christina Karen Lauridsen, Austin, TX (US); Robert Ross Peterson, Round Rock, TX (US); Lisa Anne Seacat, San Francisco, CA (US)

Correspondence Address: IBM CORP (YA);C/O YEE & ASSOCIATES PC, P.O. BOX 802333, DALLAS, TX, 75380, US

(21) Appl. No.: 11/562,825

(22) Filed: Nov. 22, 2006

(51) Int. Cl. G06F 3/12

(52) U.S. Cl. 358/1.15

(57) ABSTRACT

A system for recalling a document from a print queue log. In response to receiving a first user input to display the print queue log, print job data is retrieved. Then, the print queue log is displayed and the print queue log includes the retrieved print job data. In response to receiving a second user input to recall a selected document from the print queue log, the selected document is recalled using a selected document recall option. In response to recalling the selected document, the selected document is opened and displayed.

### BACKGROUND OF THE INVENTION

1. Field of the Invention

The present invention relates generally to an improved data processing system. More specifically, the present invention is directed to a computer implemented method, system, and computer usable program code for recalling a document from a print queue log.

2. Description of the Related Art

Currently, a user may view titles of documents currently printing or previously printed in a print queue log user interface within a display screen of a data processing system. While viewing the print queue log, the user may desire to reopen a listed document. However, the user may not recall the location of that document. For example, the user may print an Internet Webpage and subsequently navigate away from the Website while the page prints. Or, the user may print a document from a word processing application and close the application without saving the document. Or, the user may save the document, but is unable to recall where the document is saved to.

Therefore, it would be beneficial to have an improved computer implemented method, system, and computer usable program code for recalling and opening a document from a print queue log.

### SUMMARY OF THE INVENTION

Illustrative embodiments provide a computer implemented method, system, and computer usable program code for recalling a document from a print queue log. Print job data is retrieved in response to receiving a first user input to display the print queue log. Then, the print queue log is displayed, which includes the retrieved print job data. In response to receiving a second user input to recall a selected document from the print queue log, the selected document is recalled using a selected document recall option. In response to recalling the selected document, the selected document is opened and displayed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 is a block diagram of a data processing system in which illustrative embodiments may be implemented;

FIG. 3 is a block diagram of a data processing system in accordance with an illustrative embodiment;

FIG. 4 is an exemplary illustration of a print queue log user interface in accordance with an illustrative embodiment;

FIG. 5 is a flowchart illustrating an exemplary process for recalling a document from a print queue log in accordance with an illustrative embodiment; and

FIG. 6 is a flowchart illustrating an exemplary process for checking locator paths or links to documents within a print queue log in accordance with an illustrative embodiment.

### DETAILED DESCRIPTION OF THE PREFERRED EMBODIMENT

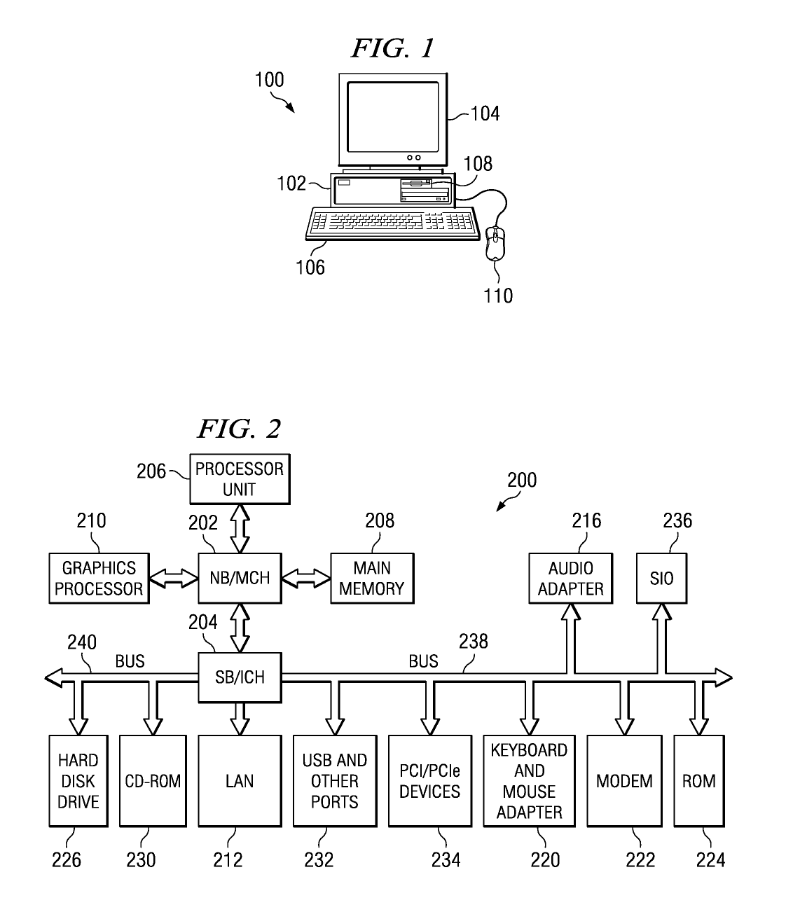

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of illustrative embodiments may be located.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows XP®. Microsoft® and Windows XP® are trademarks of Microsoft Corporation in the United States, other countries, or both. An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as HDD 226. These instructions and may be loaded into main memory 208 for execution by processing unit 206. The processes of illustrative embodiments may be performed by processing unit 206 using computer implemented instructions, which may be located in a memory. An example of a memory is main memory 208, ROM 224, or in one or more peripheral devices.

The hardware shown in FIG. 1 and FIG. 2 may vary depending on the implementation of illustrative embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, illustrative embodiments provide for a computer implemented method, system, and computer usable program code for compiling source code and for executing code. The methods described with respect to the depicted embodiments may be performed in a data processing system, such as data processing system 100 shown in FIG. 1 or data processing system 200 shown in FIG. 2.

Illustrative embodiments provide a computer implemented method, system, and computer usable program code for recalling a document from a print queue log. A print application or OS retrieves print job data in response to receiving a user input to display the print queue log. The print job data may, for example, include locators for documents listed within the print queue log. The locators contain data that the OS or print application use to locate the listed documents in order to recall the documents. A locator may, for example, be a path or link to a document.

The OS or print application displays the print queue log, which includes the retrieved print job data. After receiving a user input to recall a selected document from the print queue log, the OS or print application recalls the selected document using a selected document recall option. A document recall option is an option to recall either a current, print spool, or cached version of the selected document. In response to recalling the selected document, the OS or print application opens the selected document using an appropriate application, such as a word processing application for text documents, and then displays the selected document within a display screen.

Illustrative embodiments extend print queue log functionality by allowing a user to view, select, recall, and open documents listed within the print queue log. The print queue log lists currently printing, or previously printed, documents for a data processing system. The term “currently printing” means documents waiting to print or documents currently printing. The term “document” means any type of printable text, image, and picture, or any combination thereof. This includes word processing application documents and files, digital images and pictures, Websites, Web pages, electronic mail (e-mail), instant messaging (IM) messages, and the like. The term “recall” means the ability to find or locate the selected document in order to reopen the selected document.

Also, illustrative embodiments may, for example, present the user with document recall options. Document recall options are a list of options that the user may select from to determine which version of the selected document to recall. For example, a list of document recall options may be: 1) recall current version of document, if available; 2) recall print spool version of document; and 3) recall a cached version of the document. However, it should be noted that illustrative embodiments are not limited to the above-listed document recall options. Illustrative embodiments may include more or fewer versions of the document as recall options. In addition, illustrative embodiments may utilize only one or two recall options.

Of course, those of ordinary skill in the art will appreciate that illustrative embodiments utilize known paths, or links, to locate the selected document version in order to recall and open the document. For example, the known path may be a memory location, such as C:/test.txt, which stores the selected document within a data processing system or a known link may be a uniform resource locator (URL), such as http://www.ibm.com, to a remote Website. Illustrative embodiments perform this recall process by storing the document type and location path or link to a current version, print spool version, and/or cached version of the document on a non-volatile storage device, such as, for example, a hard disk and/or CD-ROM.

In the case of storing the location of a printed Website, illustrative embodiments may, for example, store the Website URL within the non-volatile storage unit as the locator path or link to the document. Alternatively, illustrative embodiments may store the hypertext markup language (HTML) and/or images of the printed Website within the non-volatile storage unit in addition to, or instead of, the URL. In the case of storing the location of a printed e-mail, illustrative embodiments may, for example, store e-mail account data, such as, e-mail address, password, service provider database location of the e-mail, etc., within the non-volatile storage unit as the locator path or link to the document. Alternatively, illustrative embodiments may store the content of the e-mail and all attachments within the non-volatile storage unit in addition to, or instead of, the e-mail account data. In the case of a printed word processor document, the locator path or link to the current version of the document may, for example, be C:/test.txt.

In addition, after recalling the selected document using the selected link or path, illustrative embodiments determine the appropriate application to open the document. For example, illustrative embodiments may utilize a Web browser, such as Microsoft® Internet Explorer®, to open a Website using the URL link or a word processing program, such as Microsoft® Word, to open a text document using a C:/test.doc path.

Moreover, illustrative embodiments also may automatically check document locator paths/links to documents listed in the print queue log on a predetermined basis, such as once every twenty-four hours. In response to determining that it is time to perform document locator path/link checks, the OS or print application retrieves the print job data. The print job data includes the document locator paths/links for locating the documents listed in the print queue log. The OS or print application checks the document locator paths/links to determine if any of the locator paths/links are broken. A user may break a document locator path/link by, for example, moving or deleting the document from the document's original location. If the user breaks a document locator path/link, the OS or print application will no longer be able to recall the document from the print queue log. Consequently, if an illustrative embodiment determines that a document listed in the print queue log is not automatically recalled using the document's locator path/link, the OS or print application sends a notification message to the user to inform the user of the broken locator path/link.

Furthermore, illustrative embodiments also may be utilized in a network environment. For example, in a network environment, a user may recall or retrieve a document that was originally printed from another network computer or device. However, it should be noted that the user may access and recall only those documents which the user has authorization to access within the network. For example, the network may not permit the user to view all documents printed on the network, but only those documents printed by computers or devices the user has authorization to access. In other words, the network may restrict access to certain computers, printers, documents, and files based on user name and password.

Illustrative embodiments that utilize the network environment store the original printed documents, spool versions of the printed documents, and cached versions of the printed documents on the computer or device in which the document originated. In addition, a printer may, for example, retain the history of the printed document, the computer the document printed from, and the location of the document within the computer, so that other network users may view the document. Further, the network software may, for example, store the document location information in a shared location that every authorized computer and printer on the network has access to. This shared location may, for example, be a central print history database. The central print history database is similar to the print queue log for a single data processing system. However, the central print history database includes print queue logs, along with the associated locator paths and links to listed documents within the central print history database, for a plurality of data processing systems within a network.

Therefore, a user utilizing an illustrative embodiment is not required to remember or know the location of printed documents. In addition, even if the user remembers or knows the location of the printed documents, illustrative embodiments offer a faster and easier method to view, select, recall, open, and display a desired document from among the list of printed documents in the print queue log. As a result, a user's satisfaction is greatly increased by having the ability to recall documents from a print queue log using illustrative embodiments.

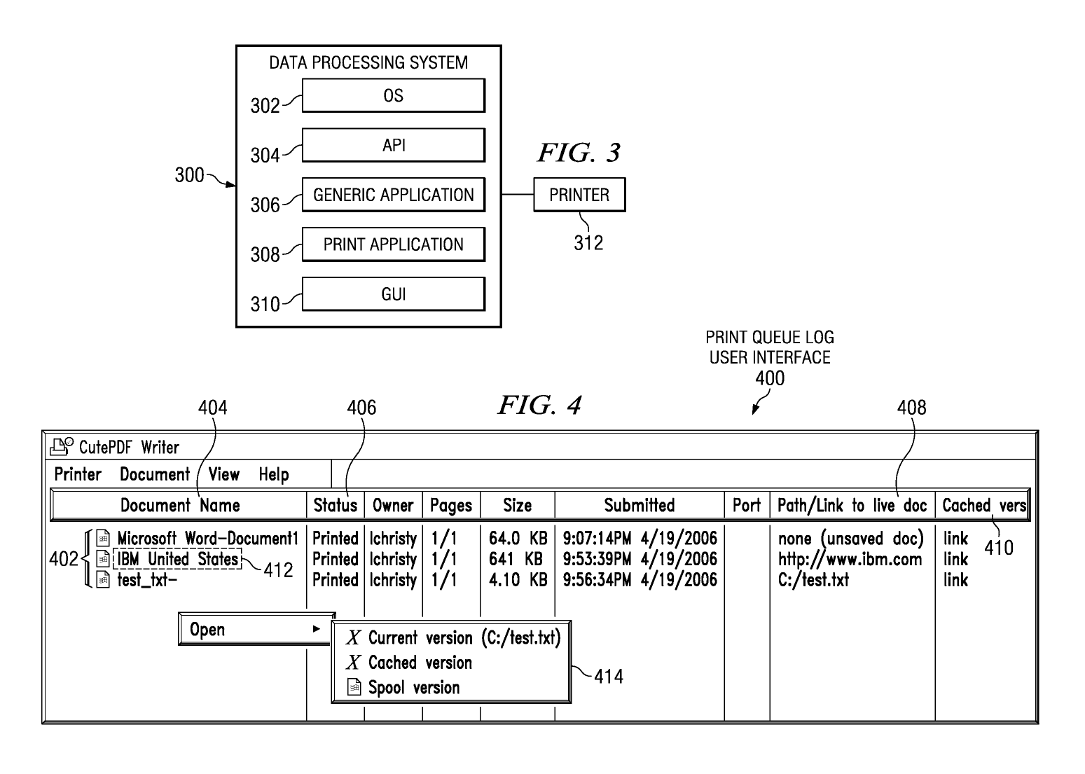

With reference now to FIG. 3, a block diagram of a data processing system is depicted in accordance with an illustrative embodiment. Data processing system 300 may, for example, be implemented in data processing system 200 in FIG. 2. However, it should be noted that the example depicted in FIG. 3 is only intended for the purpose of illustration and does not imply any architectural limitations on illustrative embodiments. Illustrative embodiments may include any components necessary to accomplish the task of recalling a printed document from a print queue log.

In the depicted example of FIG. 3, data processing system 300 includes OS 302, application programming interface (API) 304, generic application 306, print application 308, GUI 310, and printer 312. It should be noted that illustrative embodiments may reside in OS 302 and/or print application 308. OS 302 runs on a processor, such as processor unit 206 in FIG. 2, and provides high-level control of the components within data processing system 300. API 304 allows a user of data processing system 300, which may be an individual or a software routine, to invoke system capabilities using a standard consistent interface without concern for how the particular functionality is implemented.

Generic application 306 represents any type of application, such as, for example, a word processing application, Web browser application, e-mail application, instant messaging application, video conferencing application, and the like, which a user may print text, images, and/or pictures from. Data processing system 300 utilizes print application 308 to receive and queue print jobs for printing. Print application 308 receives the print jobs from generic application 306. Print application 308 uses printer 312 to print documents within the print queue log. Printer 312 is coupled to data processing 300 via wire or wireless means. Printer 312 may represent any type of commercially available printer system.

A user of data processing system 300 utilizes GUI 310 to interact with programs and applications residing within data processing system 300, such as, for example, OS 302, generic application 306, and print application 308. GUI 310 is a graphics-based user interface that incorporates movable windows and icons, which may be displayed in a display screen and manipulated by user input devices. For example, GUI 310 may be displayed in video display terminal 104 and manipulated by keyboard 106 and mouse 110 in FIG. 1. Typically, GUI 310 is the standard way a user interacts with a computer.

With reference now to FIG. 4, an exemplary illustration of a print queue log user interface is depicted in accordance with an illustrative embodiment. An OS and/or print application, such as, for example, OS 302 and print application 308 in FIG. 3, which utilizes an illustrative embodiment, displays print queue log user interface 400. The OS and/or print application may display print queue log user interface 400 in, for example, a GUI, such as GUI 310 in FIG. 3, for a user to interact with the illustrative embodiment. Print queue log user interface 400 is an exemplary user interface that a user may utilize to view a print queue log, such as print queue log 402.

Print queue log 402 is a list of currently printing and previously printed documents for a data processing system, such as data processing system 300 in FIG. 3. Print queue log 402 includes document name 404, status 406, locator path/link 408, and cached version 410. However, it should be noted that print queue log 402 may include any information necessary for processes of illustrative embodiments to recall a document from print queue log 402. Document name 404 includes the names of currently printing or previously printed documents within print queue log 402. A user using a keyboard or mouse, such as, for example, keyboard 106 and mouse 110 in FIG. 1, may select a desired document for recall from among the documents listed in document name 404. Document status 406 indicates the status, such as, for example, printing or printed, of the documents listed within print queue log 402. Document locator path/link 408 lists the respective paths or links to the documents listed within print queue log 402, which the OS and/or print application utilizes to recall the user-selected document. Document cached version 410 indicates whether a cached version of the respective documents within print queue log 402 exists.

In the example of FIG. 4, the user selects document 412 for recall within print queue log 402. Document 412 has a name of “IBM United States”, status of “printed”, and locator path/link of “http://www.ibm.com”, which is a URL. Also, document 412 indicates that a locator link to a cached version of document 412 exists. Furthermore, after the user selects document 412 for recall, document recall option menu 414 appears.

Document recall option menu 414 lists the available document versions for recall of document 412. The user utilizes document recall option menu 414 to select which document recall option the user wishes for the OS and/or print application to use to recall selected document 412. In this particular illustration, the user may select from either the current version, cached version, or print spool version to recall selected document 412.

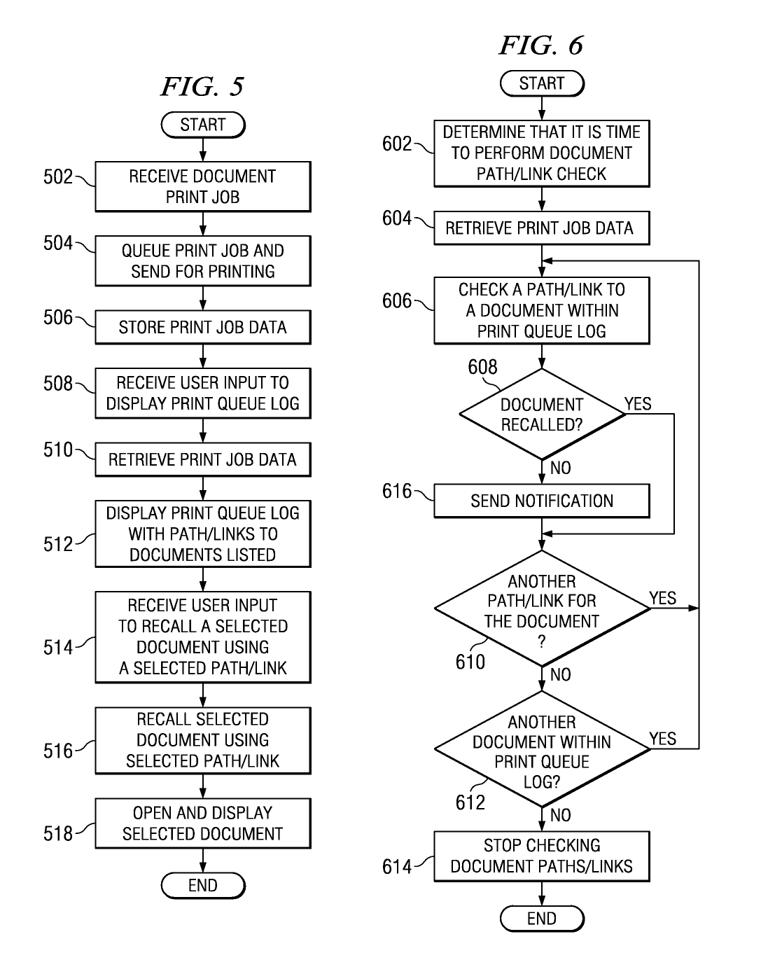

With reference now to FIG. 5, a flowchart illustrating an exemplary process for recalling a document from a print queue log is shown in accordance with an illustrative embodiment. The process shown in FIG. 5 may be implemented in a print application, such as, for example, print application 308 in FIG. 3. Alternatively, the process shown in FIG. 5 may be implemented in an OS, such as, for example, OS 302 in FIG. 3.

The process begins when the print application receives a document print job from an application, such as, for example, generic application 306 in FIG. 3 (step 502). Subsequent to receiving the document print job in step 502, the print application queues and sends the print job to a printer, such as, for example, printer 312 in FIG. 3, for printing (step 504). Concurrent with, or subsequent to, queuing and sending the print job for printing, the print application stores print job data within a non-volatile storage device, such as, for example, hard disk 226 and/or ROM 224 in FIG. 2 (step 506). The print job data may, for example, include the name and type of document selected from the print queue log and locator path or link to the current version of the selected document. In addition, the print job data also may include locator paths or links to cached and print spool versions of the selected document.

After the print application stores the print job data in step 506, the print application receives a user input to display a print queue log, such as, for example, print queue log 402 in FIG. 4 (step 508). Subsequent to receiving the user input to display the print queue log in step 508, the print application retrieves the print job data, which includes the locator paths and/or links to the documents listed within the print queue log, from the non-volatile storage device (step 510). After retrieving the print job data in step 510, the print application displays the print queue log, which contains a list of currently printing or previously printed documents, along with the documents' associated locator paths or links, within a display screen, such as, for example, video display terminal 104 in FIG. 1 (step 512). Alternatively, the print application does not display locator paths or links until the user selects a particular document within the print queue log document list.

Subsequent to displaying the print queue log in step 512, the print application receives a user input to recall a selected document using a selected locator path or link (step 514). After receiving the user input to recall the selected document using the selected locator path or link in step 514, the print application recalls the selected document (step 516). Subsequent to recalling the selected document in step 516, the print application opens the selected document using an appropriate application, such as, for example, a Web browser for a URL, and displays the selected document within the display screen (step 518). The process terminates thereafter.

With reference now to FIG. 6, a flowchart illustrating an exemplary process for checking locator paths or links to documents within a print queue log is shown in accordance with an illustrative embodiment. The process shown in FIG. 5 may be implemented in a print application, such as, for example, print application 308 in FIG. 3. Alternatively, the process shown in FIG. 5 may be implemented in an OS, such as, for example, OS 302 in FIG. 3.

The process begins when the print application determines that it is time to perform a check of all document locator paths or links associated with documents listed within a print queue log, such as, for example, print queue log 402 in FIG. 4 (step 602). A developer may program the print application to perform the document locator path or link check on a pre-determined time interval basis, such as, for example, once a day, week, or month. Alternatively, the print application may provide the user with an option to manually schedule the time interval period for performing the document locator path or link check.

Subsequent to determining that it is time to perform a document locator path or link check in step 602, the print application retrieves print job data from a non-volatile storage device, such as, for example, hard disk 226 and/or ROM 224 in FIG. 2 (step 604). After retrieving the print job data from the non-volatile storage device in step 604, the print application checks a locator path or link to a document listed within the print queue log (step 606). Subsequent to checking the locator path or link to the document in step 606, the print application makes a determination as to whether the document is recalled using the associated locator path or link (step 608).

If the document is recalled using the associated locator path or link, yes output of step 608, the print application makes a determination as to whether another locator path or link is associated with the document (step 610). If another locator path or link is associated with the document, yes output of step 610, then the process returns to step 606 where the print application checks the locator path or link. If another locator path or link is not associated with the document, no output of step 610, then the print application makes a determination as to whether another document is listed within the print queue log (step 612).

If another document is listed within the print queue log, yes output of step 612, then the process returns to step 606 where the print application checks a locator path or link to the document. If another document is not listed within the print queue log, no output of step 612, then the print application stops checking document locator paths and links (step 614). The process terminates thereafter.

Returning now to step 608, if the document is not recalled using the associated locator path or link, no output of step 608, the print application sends a notification message to the user, via a default or user-selected method, to inform the user that the document locator path or link is “broken” (step 616). The document locator path or link may be broken by, for example, moving the document from the document's original storage location or deleting the document from the original storage location. The method of notification may, for example, be via electronic mail (e-mail), instant messaging (IM), text message, or popup dialog window.

In addition, the user may customize the broken locator path or link notification in a number of ways. For example, the user may specify notification by document type, such as portable document format (PDF) documents. In other words, the user may only want to be notified about broken locator paths or links to PDF documents. Or, the user may desire notification by time period. Perhaps, the user may only want to be notified about locator paths or links broken within the last week. Or, the user may desire notification by document grouping. The user may define a group of documents that the user wishes to receive notification of broken locator paths or links.

In an alternative illustrative embodiment, the print application provides the user with an option to receive immediate notification when a document locator path or link is about to be broken. This alternate illustrative embodiment involves augmenting move and remove OS calls. Consequently, when a user attempts to move or remove a document from the document's original location, the print application makes a query on the document's locator path or link using the print job data. If the print application finds that the user is about to break the document locator path or link, the print application alerts the user via, for example, a pop-up or dialogue window, and requests confirmation to continue with the move/remove operation.

Further, the print application provides the user with an option to update the print job data to reference the document's new location. As a result, the next time the user accesses the print queue log, the print application displays the updated locator path or link to the document. In addition, the print queue log may optionally include a history of previous locations for the document. Of course, this implementation applies to the current version, print spool version, and cached version of the document.

Thus, illustrative embodiments provide a computer implemented method and computer usable program code for recalling a document from a print queue log. The invention can take the form of an entirely hardware embodiment, an entirely software embodiment or an embodiment containing both hardware and software elements. In a preferred embodiment, the invention is implemented in software, which includes but is not limited to firmware, resident software, microcode, et cetera.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a ROM, a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for recalling a document from a print queue log, the computer implemented method comprising:
responsive to receiving a first user input to display the print queue log, retrieving print job data to form retrieved print job data;
displaying the print queue log, wherein the print queue log includes the retrieved print job data;
responsive to receiving a second user input to recall a selected document from the print queue log, recalling the selected document using a selected document recall option;
responsive to recalling the selected document, opening the selected document; and
displaying the selected document.

2. The computer implemented method of claim 1, wherein the print job data includes at least one of a path or a link for locating the selected document.

3. The computer implemented method of claim 1, wherein the selected document recall option includes recalling one of a current version, a print spool version, or a cached version of the selected document.

4. The computer implemented method of claim 1, wherein the selected document is recalled from a central print history database.

5. The computer implemented method of claim 1, wherein the document includes any printable text, image, picture, or combination thereof.

6. The computer implemented method of claim 5, wherein the document is one of a Website or an electronic mail.

7. A computer program product for recalling a document from a print queue log, the computer program product comprising:
a computer usable medium having computer usable program code embodied therein, the computer usable medium comprising:
computer usable program code configured to retrieve print job data to form retrieved print job data in response to receiving a first user input to display the print queue log;
computer usable program code configured to display the print queue log, wherein the print queue log includes the retrieved print job data;
computer usable program code configured to recall a selected document using a selected document recall option in response to receiving a second user input to recall the selected document from the print queue log;
computer usable program code configured to open the selected document in response to recalling the selected document; and
computer usable program code configured to display the selected document.

8. A computer implemented method for checking a document locator for a document listed in a print queue log, the computer implemented method comprising:
responsive to determining that it is time to perform a document locator check, retrieving print job data to form retrieved print job data, wherein the retrieved print job data includes the document locator for locating the document listed in the print queue log;
checking the document locator; and
responsive to determining that the document listed in the print queue log is not recalled using the document locator, sending a notification.
